(19) United States
(12) Patent Application Publication
(10) Pub. No.: US 2011/0020100 A1
(43) Pub. Date: Jan. 27, 2011

(54) Loading Mechanism

(75) Inventors: Robert Noel Kirby, Te Puke (NZ); Peter Anderson, Tauranga (NZ)

Correspondence Address: LAFKAS LLC, PO Box 43289, CINCINNATI, OH, 45243-0289, US

(73) Assignee: Kan Holdings Limited, Tauranga (NZ)

(21) Appl. No.: 12/757,099

(22) Filed: Apr. 9, 2010

(30) Foreign Application Priority Data
Apr. 9, 2009 (NZ) 576173

(51) Int. Cl. B60P 1/04

(52) U.S. Cl. 414/480

(57) ABSTRACT

The present invention relates to a device for loading and unloading objects onto trailers. The device has particular application for use with boats and boat trailers. A telescoping frame is used to provide a retractable extension that assists in moving a boat onto and off a trailer.

### TECHNICAL FIELD

Loading mechanisms and in particular loading mechanisms for use with trailers

### BACKGROUND ART

Trailers are well known to carry loads. One of the most common loads carried on a trailer is a boat.

Boat trailers have a frame mounted on wheels. A tow bar connects the trailer to a towing vehicle. Rollers mounted on the frame allow the boat to be moved easily on and off the trailer. Winches are secured to the frame to assist moving the boat from the water, and on to the frame.

To launch a boat the trailer is backed into the water. When the trailer is suitably submerged, the boat can be pushed backwards, or simply floated off the trailer.

The trailer is then removed from the water and the boat used. After use the boat can be re-loaded onto the trailer by simply reversing the unloading process.

However, this way of loading and unloading a boat involves submerging a substantial portion of the trailer in water. The contact with water, and in particular salt water, causes corrosion. Corrosion damages trailers so that these wear out and need to be replaced.

Telescoping trailers are known as a way to avoid submerging the trailer in water.

An example of a telescoping trailer is that disclosed in New Zealand Patent No. 330895. The trailer of Patent No. 330895 has a frame with wheels.

The frame engages the tow bar of a vehicle to facilitate the trailer being towed.

Pivotal attachment of the arm to the frame allows the orientation of the frame relative to the ground to change.

A two part telescoping frame is mounted to the frame. The telescoping frame has a cradle to receive and support the boat.

In use, the entire telescoping frame is pivoted about the trailer frame. This changes the angle of the cradle with respect to the ground.

The telescoping frame is then extended to move the cradle away from the trailer and towards the water. This unloads the boat off the trailer. A person pushes the boat so that it is floated into the water off from the cradle. The telescoping frame can then be retracted and the trailer moved to a storage position.

To load the boat, the telescoping frame is extended into the water. The boat is lined up with the telescoping frame and cradle. A winch is used to draw the boat onto the cradle. The winch continues drawing the cradle (and the boat which it supports) to retract the telescoping frame onto the boat trailer. Continued winching causes the telescoping frame to pivot and change the orientation of the entire telescoping frame to the ground. The telescoping frame can then be locked in the towing position.

The boat trailer disclosed by Patent No. 330895 has a number of limitations. Firstly, loading and unloading involves pivoting of the entire telescoping frame.

In addition, the boat trailer is not ideal for use in loading boats in shallow waters due to the angle of the telescoping frame when this is pivoted.

Further, the pivoting frame must be incorporated at manufacture of the boat trailer and the telescoping frame cannot be easily retrofitted to an existing boat trailer.

Yet a further limitation is that the pivoting arrangement of the frame with respect to the boat trailer is complex. Therefore it is more expensive and costly to manufacture.

Another example of a tilting boat trailer is disclosed in New Zealand Patent Nos. 571730 and 572726 which disclose self-propelled vessel launching and retrieve vehicles. FIGS. 7 and 9 of these patents disclose that the vehicles have a sub-frame which is capable of pivoting with respect to a main frame of the vehicle.

In use, a boat is moved over the subframe and onto the main frame. Therefore the subframe assists in loading and unloading a vessel onto the vehicle.

However, the vessel launching and retrieve vehicles of Patent Nos. 571730 and 572726 are complicated. In addition, they can not be easily incorporated into existing boat trailers.

Further, the sub-frame does not move along the length of the main frame. Therefore, these devices are not particularly long, which may hinder them launching boats without submerging the entire vehicle in water.

In addition, the relative orientation of the sub-frame may make it difficult to drag a boat onto the main frame.

New Zealand Patent No. 547569 discloses an easy load boat trailer. The trailer is formed from a Y shaped frame which can be connected to a vehicle.

A U shaped frame is attached to the Y shaped frame by two offset arms. The arms swivel on pins that are fixed to the frame.

A hydraulic cylinder applies pressure to the Y shaped frame causing it to swivel on the axis, thereby moving they Y shaped frame between loading and storage positions.

The orientation of the swivel arms and cylinder is such that the U shaped frame is maintained substantially horizontal during operation.

The trailer disclosed by Patent No. 547569 must be submerged in water to load and unload the trailer. Therefore the trailer is prone to corrosion.

It would be advantageous to have a boat trailer which facilitates loading and unloading of boats without submerging parts of the trailer substantially into water.

In addition, it would be advantageous to have an alternative to the trailers available in the prior art.

Yet a further advantage would be to have a mechanism which can be easily retrofitted to an existing trailer and which facilitates loading of boats without submerging the trailer in the water.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DISCLOSURE OF THE INVENTION

According to one aspect of the present invention, there is provided a loading mechanism, including

a telescoping frame having a first component and a second component,

the second component being configured to move with respect to the first component between a retracted position and an extended position,

the first component being configured to be secured to a trailer, characterised in that the loading mechanism includes

a hinge such that when in the extended position the second component can pivot with respect to the first component to provide a ramp to facilitate loading and unloading an object onto and off from the trailer.

According to a further aspect of the present invention, there is provided a loading method, wherein the method uses a loading mechanism including a telescoping frame having a first component and a second component and a hinge between the first and second components, the method including the steps of:

(a) securing the first component to a trailer;

(b) positioning the trailer with respect to where an object is to be loaded or unloaded;

(c) moving the second component with respect to the first component to an extended position;

the method characterised by the step of

allowing the second component of the telescoping frame to move about the hinge such that it can provide a ramp to load and unload an object onto or off the trailer.

According to another aspect of the present invention, there is provided a trailer including a loading mechanism as described above.

Throughout the present specification reference to the term “loading mechanism” should be understood as meaning an apparatus to facilitate loading or unloading of an object.

In a preferred embodiment the present invention relates to loading mechanisms for use with trailers, and in particular boat trailers. Reference will be made herein to the loading mechanism for use with trailers.

In the preferred embodiment, the loading mechanism is used with loading and unloading a boat onto a trailer. Reference will be made herein as such. However, this should not be seen as limiting and other articles such as jet skis, motor bikes, and cars are envisaged.

In a particularly preferred embodiment the loading mechanism may be incorporated into a boat trailer at manufacture or retrofitted to an existing boat trailer.

In the embodiment where the loading mechanism is retrofitted, it has a mounting to facilitate attachment of the loading mechanism to a boat trailer. The mounting may be flanges attached to the telescoping frame to facilitate bolting the frame to the trailer. Alternatively the loading mechanism may have members which lock into recesses in the boat trailer. In yet a further embodiment the frame may be welded to a boat trailer.

Throughout the present specification reference to the term “telescoping frame” should be understood as meaning two components which can move with respect to each other to facilitate a change in length.

In a preferred embodiment, the second component is slidingly coupled to the first component, allowing it to slide from a retracted position to the extended position.

In a particularly preferred embodiment the first component may have rollers to facilitate the sliding motion of the second component, or vice versa.

Throughout the present specification, reference to the term “retracted position” should be understood as referring to a position in which the telescoping frame has been shortened. This involves the second component sliding with respect to the first component to decrease the length of the telescoping frame.

Preferably it is substantially within the dimensions of the boat trailer. This is useful as it shortens the overall length of the loading mechanism for transport purposes.

Throughout the present specification, reference to the term “extended position” should be understood as referring to a position to which the telescoping frame is lengthened. This involves the second component sliding with respect to the first component to increase the length of the telescoping frame such that it extends beyond the dimensions of the boat trailer. This is useful as it facilitates the loading and unloading of the object onto the boat trailer without the necessity of submerging the trailer in water. This should become clearer from the following description.

In a particularly preferred embodiment the first component may be two hollow extrusions. Alternatively, the first component may be two c-profile channel elements.

In the embodiment where the loading mechanism is retro-fitted to an existing boat frame, then the members forming the first component may be attached directly to the boat trailer. Alternatively, the first component may be incorporated into the boat trailer during manufacture of the trailer.

In a preferred embodiment, the second component may be two spaced apart members.

In this embodiment, the members are sufficiently spaced apart that they can sit either side of the hull of a boat frame and support or provide a plurality of rollers to facilitate the second component acting as a ramp. This assists in supporting a boat during use of the loading mechanism. This aspect should become clearer from the following description.

The second component's rollers may be raised above the second component such that they define a plane of movement for the boat at a gradient of between 5-15° to the horizontal. This makes it easier to move the boat over the second component.

It also facilitates loading/unloading boats in shallow water as the boat is not moved from the trailer at a steep angle which may cause it to contact the ground.

Throughout the present specification reference to the term “hinge” should be understood as meaning one or more parts which allow the second component of the telescoping frame to pivot with respect to the first component.

It should be appreciated that the second component pivots with respect to the first component of the telescoping frame. This is quite different to telescoping trailers known in the art where the pivoting involves moving the entire telescoping frame with respect to a boat trailer. This difference is subtle but important. For instance, the fact that the components of the telescoping frame pivot with respect to each other allows the present invention to be retrofitted to existing boat trailers. This is due to there being no need to incorporate the tilting/pivoting mechanism when manufacturer the trailer.

In addition, the relative position of the hinge may assist in loading and unloading the boat from the trailer. This is because the position of the second component relative to the first component means that it can act as a ramp to facilitate movement of the object on and off the trailer.

In a preferred embodiment the present invention may include a biasing assembly.

Throughout the present specification reference to the term “biasing assembly” should be understood as meaning a component which urges a component of the telescoping frame towards a preferred position.

The preferred position is “up” meaning that the second component has not pivoted with respect to the first component.

In a preferred embodiment, the biasing assembly may be a spring.

In a particularly preferred embodiment, the spring may be a leaf spring as known to those skilled in the art.

In this embodiment, the leaf spring may be the hinge. However it is also envisaged that known coil springs could be used to bias the second component to the desired position.

Preferably, the hinge is configured so that the second component can only pivot with respect to the first component when in the extended position. This may be achieved by the way the hinge is connected to the second component or the position of the hinge.

This feature is advantageous as it allows the second component to slide relative to the first component more easily.

Preferably, the spring may have sufficient strength to pivot the second component up and into a raised position. This position is such that the second component is able to slide from the extended position into the retracted position.

In a particularly preferred embodiment the spring should have sufficient strength to support the weight of the second component and prevent this pivoting downwards uncontrollably.

However the spring should not be so strong that a boat's weight cannot push the second component down. This should become clearer from the following description.

In a preferred embodiment, the present invention may have a locking portion.

Throughout the present specification, reference to the term “locking portion” should be understood as meaning a way to prevent the telescoping frame from overextending.

In a preferred embodiment, the locking portion may be a ridge or protrusion on the first component.

In this embodiment, the first portion of the telescoping frame abuts the protrusion/ridge when the telescoping frame is fully extended thereby preventing over extension.

The foregoing description should not be seen as limiting and alternatives are envisaged without departing from the scope of the invention.

It is also envisaged that the first component of the telescoping frame may also have rollers, or that rollers may be mounted on the boat trailer.

From the foregoing description it should be appreciated that the present invention has a number of advantages.

Firstly, the present invention is cost effective and easy to manufacture.

In addition, the present invention can be easily retrofitted to existing boat trailers.

Further, the present invention allows the loading and unloading of boats from trailers without submerging a substantial portion of the trailer into the water. This is beneficial long term in preventing corrosion, and deterioration in the quality of trailers.

The applicant has also found that the present invention makes it easier to load and unload boats from trailers. This benefit is substantively provided by having a spring between the first and second components of the telescoping frame. The spring provides an upwards biasing force against a component of the telescoping frame.

The spring also assists the second component in supporting the weight of the boat as this is moved on and off the trailer

### BRIEF DESCRIPTION OF THE DRAWINGS

Further aspects of the present invention will become apparent from the ensuing description which is given by way of example only and with reference to the accompanying drawings in which:

FIG. 1A is a side view of loading mechanism in a retracted position;

FIG. 1B is a side view of the loading mechanism in an extended position;

FIG. 2 is a plan view of the components of the loading mechanism according to the present invention;

FIG. 3A-F are schematics showing unloading a boat using the loading mechanism according to the present invention.

### BEST MODES FOR CARRYING OUT THE INVENTION

Throughout the Figures like numerals refer to like components.

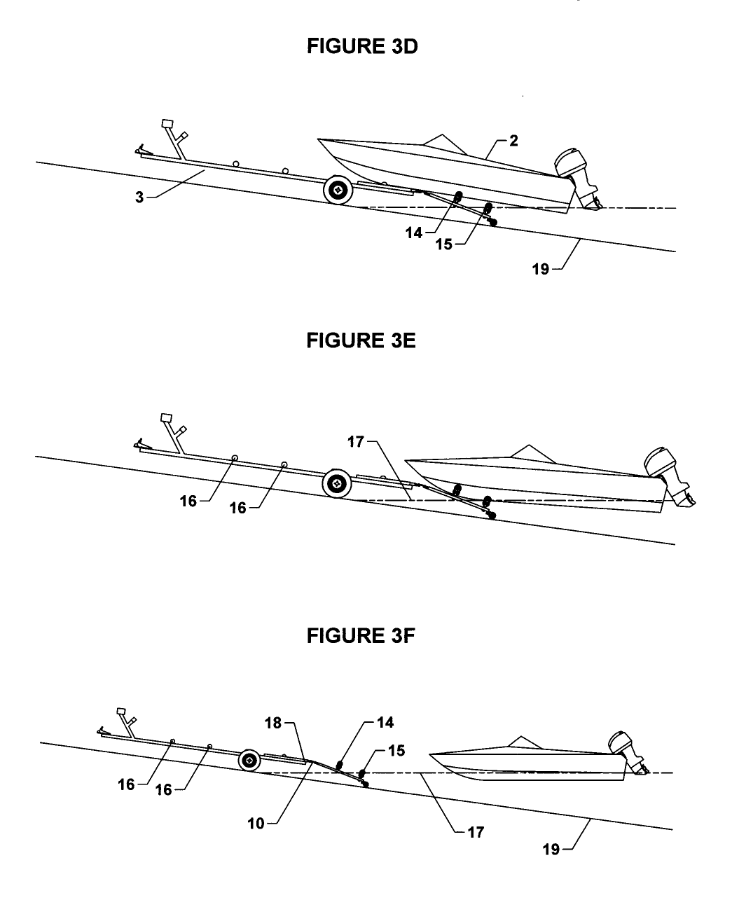

There is provided a loading mechanism (i). The loading mechanism (i) can be used with loading a boat (2) onto a trailer (3) as will be discussed below in relation to FIGS. 3A-F.

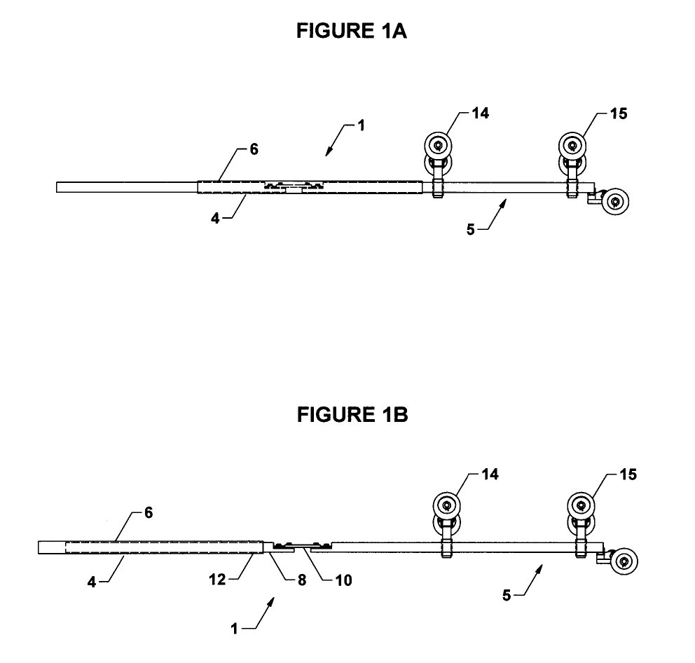

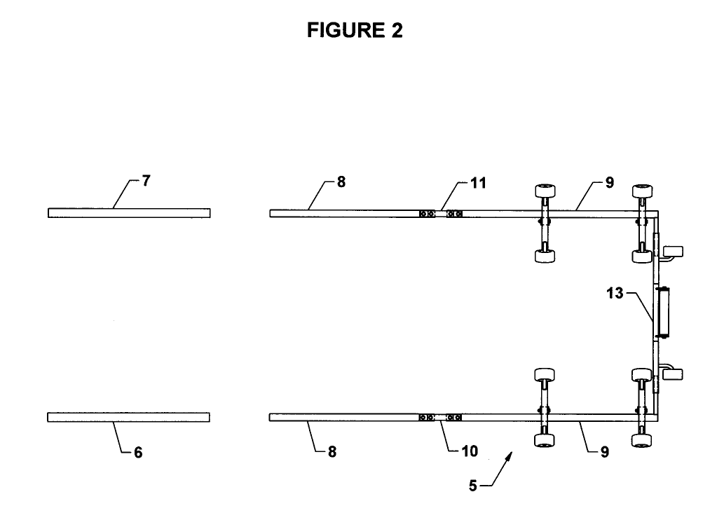

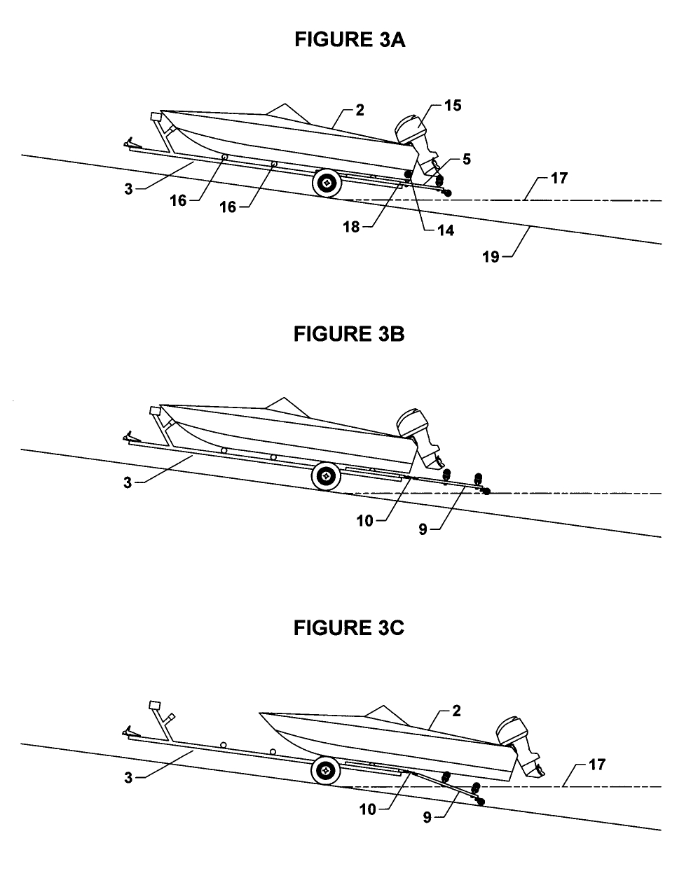

Referring first to FIGS. 1A, 1B, and 2 the loading mechanism (1) is a telescoping frame formed from a first component (4) and a second component (5) that are slidingly coupled to each other.

The first component (4) is formed of two stainless steel hollow tubes (6,7). The tubes (6,7) can be secured to a boat trailer (not shown in FIGS. 1A, 1B, and 3) via techniques such as welding.

Rollers (not shown) are rotatably mounted inside the tubes (6,7). The rollers facilitate sliding the second component (5) relative to the first component (4) between an extended position and retracted position. The extended position is shown in FIG. 1B and the retracted position is shown in FIG. 1A.

The second component (5) is formed from forward portions (8) and backward portions (9). The forward and backward portions (8,9) are attached to each other by leaf springs (10,11).

A locking mechanism is provided by ridges (12) inside the first component. The ridges abut forward portions (9) when the loading mechanism (1) is in the extended position. This prevents the second component (5) over-extending and sliding out of the first component (4).

Lateral member (13) is secured between the backward portions (9) to attach the portions (9) to each other and reinforce these.

A plurality of rollers (14) are secured to the second component (5). The rollers (14,15) assist in moving a boat (2) on to and off the loading mechanism (1). This should become clearer from the following description.

Referring now to FIGS. 3A-F showing operation of the loading mechanism (1).

A boat (2) is stored on the trailer (3) incorporating the loading mechanism (1). The boat (2) sits on a plurality of rollers (16) on the trailer ( )

A car (not shown) positions the trailer (3) adjacent to the water (17). It should be noted that in FIGS. 3A-F it is not necessary to submerge the boat trailer (2) in the water (17).

A person extends the telescoping frame so the second component (5) is fully extended beyond the back edge (18) of the trailer (3). This can occur without moving the boat. The springs (10, 11) hold the second component (5) up and in a raised position.

The person then pushes the boat (2). The boat (2) moves over the rollers (16) mounted on the boat trailer (3) and onto rollers (14,15) on the second component (5).

The boat (2) moves towards the water (17). The movement of the boat (2) causes its weight to be transferred from the first component (4) to the second component (5).

As the second component (5) is hinged to the first component (4) via the leaf springs (10,11), the second component (5) can pivot downwards towards the water (17) and ground (19). The further the boat (2) travels towards the water (17) the more pressure the boat exerts on the second component (5), therefore causing the second component (5) to pivot further downwards.

The second component (5) eventually touches the ground (18) preventing it from pivoting further.

As the boat (2) continues to move towards the water (17), the second component (5) facilitates unloading of the boat (2) into the water (17). The second component (5) acts as a ramp so that they boat can move from the trailer (2) to the water (17). This is quite distinct to the prior art where a cradle is used to move a boat from a trailer into the water.

Once the weight of the boat (2) is taken by the water (17), the leaf springs (10,11) force the second component (5) upwards.

In addition, the second component (5) provides a path with a low gradient. This makes it less difficult to load/unload the boat (2). The person can then use the car (not shown) to move the trailer (3) to a storage location. The person can retract the second component (5) onto the trailer (3) either before or after moving the trailer (3).

Loading the boat (2) onto the trailer (3) involves reversing the steps to unload the boat (2). That is, a person must position the trailer (3) next to the water (17).

The second component (8) must be moved to the extended position where it is beyond the back edge (18) of the trailer (3).

The boat (2) is aligned with the second component (5) and trailer (3). Note that the springs (10,11) hold the second component up.

A winch line (not shown in the drawings) can be attached to the boat (2). The winch moves the boat (2) onto the second component (8).

As the boat's hull (20) touches the rollers (14) it applies the boat's weight to the second component (5). The boat's weight forces the second component (5) to pivot downwards towards the ground about the leaf springs (10,11).

The winch continues to move the boat (3) onto the trailer.

The rollers (16) assist movement of the boat (2) onto the trailer (3).

Once the boat (2) is fully loaded onto the first component (4) the boat's weight does not apply pressure to the second component (5). Accordingly, the second component (5) is urged upwards by the leaf springs (10,11).

The second component (5) is moved to the retracted position and locked in place to prevent unwanted movement. The trailer (2) can then be moved as required.

Aspects of the present invention have been described by way of example only and it should be appreciated that modifications and additions may be made thereto without departing from the scope thereof as defined in the appended claims

1. A loading mechanism, including
a telescoping frame having a first component and a second component,
the first component being configured to be secured to a trailer, and
wherein the first and second components are slidingly coupled to each other such that the second component can with respect to the first component move between a retracted position and an extended position,
characterised in that the loading mechanism includes
a hinge such that when in the extended position the second component can pivot with respect to the first component to provide a ramp to load and unload an object onto and off the trailer.

2. The loading mechanism as claimed in claim 1, wherein the hinge is between the first component and the second component.

3. The loading mechanism as claimed in claim 1, including a mounting to facilitate securing the first component to the trailer.

4. The loading mechanism as claimed in claim 1, including a biasing assembly which urges the second component upwards.

5. The loading mechanism as claimed in claim 4, wherein the biasing assembly is a spring.

6. The loading mechanism as claimed in claim 5, wherein the spring is at least one leaf spring.

7. The loading mechanism as claimed in claim 6, wherein the at least one leaf spring is the hinge.

8. The loading mechanism as claimed in claim 1, including a locking mechanism to prevent the telescoping frame from overextending.

9. The loading mechanism as claimed in claim 1, wherein the second component provides rollers configured to facilitate the second component providing the ramp.

10. The loading mechanism as claimed in claim 9, wherein the rollers are raised above the second component.

11. The loading mechanism as claimed in claim 1, wherein the first component of the trailer has rollers to facilitate movement of the object from the first component onto the trailer.

12. The loading mechanism as claimed in claim 1, wherein the second component can be moved to an extended position while the object is on the trailer without moving the object.

13. (canceled)
